(19) United States
(12) Patent Application Publication
(10) Pub. No.: US 2012/0321780 A1
(43) Pub. Date: Dec. 20, 2012

(54) METHOD OF PREVENTING OXIDATION OF MULTILAYER WIRINGS IN ULTRA LARGE SCALE INTEGRATED CIRCUITS AFTER ALKALINE POLISHING

(76) Inventors: Yuling LIU, Tianjin (CN); Xiaoyan LIU, Tianjin (CN); Jun TIAN, Tianjin (CN)

(21) Appl. No.: 13/593,507

(22) Filed: Aug. 23, 2012

Related U.S. Application Data
(63) Continuation-in-part of application No. PCT/CN2010/080469, filed on Dec. 30, 2010.

(30) Foreign Application Priority Data
Jul. 21, 2010 (CN) 201010231676.3

(51) Int. Cl. B05D 5/00

(52) U.S. Cl. 427/96.2

(57) ABSTRACT

A method of preventing oxidation of multilayer wirings in ultra large scale integrated circuits after alkaline polishing, the method including: a) mixing between 0.5 and 1 wt. % of a surfactant, between 0.05 and 0.5 wt. % of a chelating agent, between 1 and 10 wt. % of a corrosion inhibitor, and deionized water, and stirring to yield a water soluble antioxidant solution with pH value of between 6.8 and 7.5; and b) washing the multilayer wirings in the ultra large scale integrated circuits using the antioxidant solution after alkaline CMP under following conditions: between 1000 and 2000 Pa pressure; between 2000 and 5000 mL/min flow rate; and at least between 0.5 and 1 min washing time.

### CROSS-REFERENCE TO RELATED APPLICATIONS

This application is a continuation-in-part of International Patent Application No. PCT/CN2010/080469 with an international filing date of Dec. 30, 2010, designating the United States, now pending, and further claims priority benefits to Chinese Patent Application No. 201010231676.3 filed Jul. 21, 2010. The contents of all of the aforementioned applications, including any intervening amendments thereto, are incorporated herein by reference.

### BACKGROUND OF THE INVENTION

1. Field of the Invention

The invention relates to a method of preventing oxidation of wafer surfaces after polishing, and more particularly to a method of preventing oxidation of multilayer wirings in ultra large scale integrated circuits after alkaline polishing.

2. Descriptions of Related Art

The increase in the density of integrated circuits and the decrease in the size of elements thereof make the capacity between wires and the resistance of metal interconnects enlarge, which results in the resistance and capacitance delay (RC delay) of metal interconnects is longer than the intrinsic RC delay of elements. Copper has lower resistivity and thermal sensitivity, and better anti-electromigration than aluminum; in addition, it produces a shorter RC delay to improve the reliability of circuits. Thus, copper wire is an ideal material for interconnection line. As the size of elements of integrated circuits becomes smaller, and the number of metal layers increases, the degree of the flattening of each layer becomes one of the important factors that affect etching linewidth of integrated circuits, and becomes a bottle-neck in the development of microelectronics. Chemical-mechanical polishing (CMP) method is so far the most effective and mature technology for flattening. However, the surface after polishing has high surface energy, large surface tension, and easy oxidation, which affects electrical properties and yields of elements, indirectly decreases the thickness of metal interconnections, and increases the resistance of intraconnection, thus the reliability of elements is decreased, and disconnections of elements may occur, thereby resulting in malfunction of the circuit, or even disastrous consequence.

A typical antioxidation method is to add a corrosion inhibitor and abrasive into a polishing solution. However, when the polishing process of the CMP method is accomplished, molecular bonds of surface atoms of copper are just broken, so that the surface has a high energy which can easily adsorb small grains to lower the surface energy. Therefore, grains of abrasive in the polishing solution are very easy to be adsorbed on the copper surface; residues of polishing solution surrounding grains have large surface tension, and are distributed as globules on copper surface, which easily results in uneven corrosion and inconvenience for the later cleaning. In order to meet requirements of the development of multilayer copper wiring, it is urgent to develop a method of preventing oxidation of multilayer copper wirings in ultra large scale integrated circuits after alkaline polishing.

### SUMMARY OF THE INVENTION

In view of the above-described problems, it is one objective of the invention to provide a method of preventing oxidation of multilayer wirings in ultra large scale integrated circuits after alkaline polishing.

To achieve the above objective, in accordance with one embodiment of the invention, there is provided a method of preventing oxidation of multilayer wirings in ultra large scale integrated circuits after alkaline polishing, the method comprising:
a) mixing between 0.5 and 1 wt. % of a surfactant, between 0.05 and 0.5 wt. % of a chelating agent, between 1 and 10 wt. % of a corrosion inhibitor, and deionized water, and stirring evenly to yield a water soluble antioxidant solution with pH value of between 6.8 and 7.5; and
b) washing the multilayer wirings in the ultra large scale integrated circuits using the antioxidant solution after alkaline CMP under following conditions to form a passive film on surfaces of the multilayer wirings:
pressure: between 1000 and 2000 Pa;
flow rate: between 2000 and 5000 mL/min; and
washing time: at least between 0.5 and 1 min.

In a class of this embodiment, the surfactant is an FA/O I surfactant, O_{π}-7 ((C₁₀H₂₁—C₆H₄—O—CH₂CH₂O)₇—H), O_{π}-10 ((C₁₀H₂₁—C₆H₄—O—CH₂CH₂O)₁₀—H), O-20(C₁₂₋₁₈H₂₅₋₃₇—C₆H₄—CH₂CH₂O)₇₀—H), or polyoxyethylene secondary alkyl alcohol ether (JFC), all of which are supplied by Tianjin Jingling Microelectronics Materials Co., Ltd. In a class of this embodiment, the chelating agent is an FA/O II chelating agent supplied by Tianjin Jingling Microelectronics Materials Co., Ltd, that is, ethylene diamine tetra-acetic acid tetra (tetra-hydroxyethyl ethylene diamine), the structural formula of which is as follows:

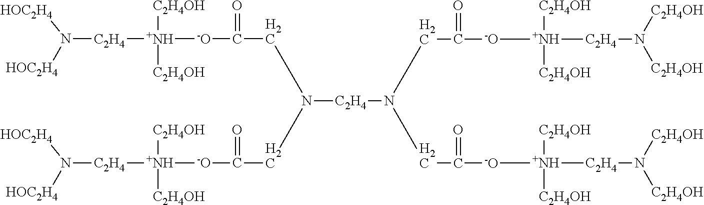

In a class of this embodiment, the corrosion inhibitor is an FA/O II corrosion inhibitor supplied by Tianjin Jingling Microelectronics Materials Co., Ltd. The FA/O II corrosion inhibitor is a complex of urotropine (hexamethylenetetramine) and benzotriazole (1,2,3-triaza-1h-indene), the molecular formula of urotropine is C₆H₁₂N₄, and the structural formula thereof is

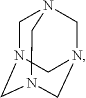

the molecular formula of benzotriazole is C₆H₅N₃, and the structural formula thereof is

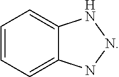

The effectiveness of the FA/O II corrosion inhibitor is 3 times stronger than that of a single benzotriazole.

Advantages of the invention is summarized below:
1. The antioxidation after CMP employs the antioxidant solution comprising surfactant, chelating agent, and corrosion inhibitor to clean multilayer wirings at a large flow rate, which prevents the wiring surface from oxidation, has no corrosion to devices, and washes away polishing solution residues on the wiring surface to yield a clean and perfect polished surface.
2. As multilayer wirings have high surface energy during the process of polishing, the FA/O II corrosion inhibitor in the antioxidant solution is easy to form a single molecular passive film, thereby preventing the polished wirings from oxidation and assuring the cleanness and perfectness of wiring surfaces.

### DETAILED DESCRIPTION OF THE EMBODIMENTS

To further illustrate the invention, experiments detailing a method of preventing oxidation of multilayer wirings in ultra large scale integrated circuits after alkaline polishing are described below. It should be noted that the following examples are intended to describe and not to limit the invention.

### EXAMPLE 1

Preparation of 2500 g of an antioxidant solution for multilayer wirings:

To 2236.25 g of 18 MΩ ultrapure deionized water, 12.5 g of an FA/O I surfactant, 1.25 g of an FA/O II chelating agent, and 250 g of an FA/O II corrosion inhibitor was added and stirred. Subsequently, 2500 g of an antioxidant solution with pH value of between 6.8 and 7.5 was collected. After alkaline CMP, multilayer wirings were washed with the prepared antioxidant solution under 1000 Pa of a low pressure and 5000 mL/min of a flow rate for 0.5 min. Surfaces of multilayer wirings were finally observed under an OLYMPUS BX60M metallographic microscope to make sure surfaces clean and without oxidized layers.

The surfactant is an FA/O I surfactant, O_{π}-7 ((C₁₀H₂₁—C₆H₄—O—CH₂CH₂O)₇—H), O_{π}-10 ((C₁₀H₂₁—C₆H₄—O—CH₂CH₂O)₁₀—H), O-20 (C₁₂₋₁₈H₂₅₋₃₇C₆H₄—O—CH₂CH₂O)₇₀—H), or (JFC).

The FA/O I surfactant, the FA/O II chelating agent, and the FA/O II corrosion inhibitor all are supplied by Tianjin Jingling Microelectronics Materials Co., Ltd.

### EXAMPLE 2

Preparation of 3000 g of an antioxidant solution for multilayer wirings:

To 2925 g of 18 MΩ ultrapure deionized water, 30 g of an FA/O I surfactant, 15 g of an FA/O II chelating agent, and 30 g of an FA/O II corrosion inhibitor was added and stirred. Subsequently, 3000 g of an antioxidant solution with pH value of between 6.8 and 7.5 was collected. After alkaline CMP, multilayer wirings were washed with the prepared antioxidant solution under 2000 Pa of a low pressure and 2000 mL/min of a flow rate for 1 min. Surfaces of multilayer wirings were finally observed under an OLYMPUS BX60M metallographic microscope to make sure surfaces clean and without oxidized layer.

Selections of the FA/O I surfactant, the FA/O II chelating agent, and the FA/O II corrosion inhibitor were same as those of Example 1.

### EXAMPLE 3

Preparation of 3500 g of an antioxidant solution for multilayer wirings:

To 3265 g of 18 MΩ ultrapure deionized water, 20 g of an FA/O I surfactant, 15 g of an FA/O II chelating agent, and 200 g of an FA/O II corrosion inhibitor was added and stirred. Subsequently, 3500 g of an antioxidant solution with pH value of between 6.8 and 7.5 was collected. After alkaline CMP, multilayer wirings were washed with the prepared antioxidant solution under 1500 Pa of a low pressure and 4000 mL/min of a flow rate for 1 min. Surfaces of multilayer wirings were finally observed under an OLYMPUS BX60M metallographic microscope to make sure surfaces clean and without oxidized layer.

Selections of the FA/O I surfactant, the FA/O II chelating agent, and the FA/O II corrosion inhibitor were same as those of Example 1.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method of preventing oxidation of multilayer wirings in ultra large scale integrated circuits after alkaline polishing, the method comprising:
a) mixing between 0.5 and 1 wt. % of a surfactant, between 0.05 and 0.5 wt. % of a chelating agent, between 1 and 10 wt. % of a corrosion inhibitor, and deionized water, and stirring to yield a water soluble antioxidant solution with pH value of between 6.8 and 7.5; and
b) washing the multilayer wirings in the ultra large scale integrated circuits with the antioxidant solution after alkaline CMP under the following conditions to form a passive film on surfaces of the multilayer wirings:
pressure: between 1000 and 2000 Pa;
flow rate: between 2000 and 5000 mL/min; and
washing time: at least between 0.5 and 1 min.

2. The method of claim 1, wherein the surfactant is an FA/O I surfactant, O_{π}-7 ((C₁₀H₂₁—C₆H₄—O—CH₂CH₂O)₇—H), O_{π}-10 ((C₁₀H₂₁—C₆H₄—O—CH₂CH₂O)₁₀—H), O-20 (C₁₂₋₁₈H₂₅₋₃₇—C₆H₄—O—CH₂CH₂O)₇₀—H), or polyoxyethylene secondary alkyl alcohol ether.

3. The method of claim 1, wherein the chelating agent is an FA/O II chelating agent: ethylene diamine tetra-acetic acid tetra (tetra-hydroxyethyl ethylene diamine).

4. The method of claim 1, wherein the corrosion inhibitor is an FA/O II corrosion inhibitor.
